(19) United States
(12) Patent Application Publication
(10) Pub. No.: US 2009/0184517 A1
(43) Pub. Date: Jul. 23, 2009

(54) JOINING STRUCTURE OF TANK COMPONENTS

(76) Inventor: Toru Mukai, Aichi (JP)

Correspondence Address: KENYON & KENYON LLP, 1500 K STREET N.W., SUITE 700, WASHINGTON, DC, 20005, US

(21) Appl. No.: 12/296,582

(22) PCT Filed: Mar. 30, 2007
(86) PCT No.: PCT/JP2007/057697

§ 371 Date: Oct. 9, 2008

(30) Foreign Application Priority Data
Apr. 11, 2006 (JP) 2006-108610

(51) Int. Cl. F17C 13/04; F16L 15/08; F16L 23/16

(52) U.S. Cl. 285/357; 285/363

(57) ABSTRACT

It is realized to prevent foreign matter from being produced due to abrasion or cutting of a bearing surface by improving abrasion resistance of the bearing surface. It is also realized to prevent the foreign matter from entering into a tank via the opening of a mouthpiece even when it is produced. The joining structure of tank components comprises a screw joining unit for joining with the mouthpiece of a high-pressure tank, a bearing surface axially contacting the mouthpiece on the tank component side, a bearing surface on the mouthpiece side, contacting the tank component side bearing surface, a recess provided on the inner peripheral side of a portion where the tank component side bearing surface contacts the mouthpiece side bearing surface with each other and on the outer peripheral side of an opening and forming a space between the tank component and the mouthpiece, and a seal member provided in the recess for preventing foreign matter intrusion into the opening in the mouthpiece. It is preferable to treat the surface of at least one of the tank component side bearing surface and the mouthpiece side bearing surface for abrasion resisting.

### BACKGROUND OF THE INVENTION

1. Field of the Invention

The present invention relates to a joining structure of tank components. More particularly, it relates to the improvement of a structure for joining a component such as a valve assembly by use of screws in a high-pressure tank for use in the storage of hydrogen or the like.

2. Description of Related Art

As a high-pressure tank for use in the storage of hydrogen or the like, there has been used a tank having a structure where a valve assembly (a component in which a high-pressure valve and the like are embedded) is attached to a mouthpiece provided in a tank opening. Moreover, to attach the valve assembly to the mouthpiece, a joining structure of tank components has frequently been used in which a simple thread structure for engaging an external thread portion of the valve assembly with an internal thread portion of the mouthpiece is used (e.g., see Patent Document 1).

In such a joining structure of the tank components, a high inner pressure of, for example, 35 MPa or 70 MPa as the case may be is received by not only a screw joining unit but also a bearing surface, so that a joining load of a tank component such as the valve assembly needs to be increased to such an extent as to bear the pressure.

[Patent Document 1] Japanese Patent Application Laid-Open No. 2005-291434

### SUMMARY OF THE INVENTION

However, a load received by a bearing surface as described above considerably increases, so that during attachment/detachment of tank components, the bearing surface is abraded or cut, and foreign matter such as cutting residue, burr or fine dust is sometimes generated. Moreover, such foreign matter might enter into (intrude into) a high-pressure tank from an opening of a mouthpiece.

Therefore, an object of the present invention is to provide a joining structure of tank components capable of suppressing the generation of foreign matter due to abrasion or cutting of a bearing surface. Another object is to provide a joining structure of tank components capable of preventing the foreign matter from entering into a tank via the opening of a mouthpiece even when it is generated.

To solve such a problem, the present inventor has performed various investigations. An aluminum material is sometimes applied to a mouthpiece portion or a valve assembly so as to decrease as much as possible the weight of a high-pressure tank which tends to increase its weight. In this case, lightening can be achieved, but during the fastening of the valve assembly, the contact surfaces of both components (e.g., the bearing surface of the mouthpiece) are damaged, and this causes a problem that the components cannot be reused as the case may be. Moreover, in a case where not only the damage but also cutting residue, burr, dust or the like is generated, there occurs a problem that foreign matter like these might enter into the tank through the mouthpiece. In this respect, at the present moment, to lighten the mouthpiece and the valve assembly is one theme, and hence the restoring of the material cannot be a countermeasure. Therefore, from a viewpoint that the damage or the foreign matter should not be generated or from a viewpoint that the foreign matter should be prevented from entering (intruding) into the tank even when it is generated, the present inventor has further performed investigation, and has found a technology for solving the problem.

The present invention has been developed based on such finding, and there is provided a joining structure of tank components to be joined to a mouthpiece of a high-pressure tank, comprising: a screw joining unit to be joined to the mouthpiece; a tank component side bearing surface which axially comes in contact with the mouthpiece; and a mouthpiece side bearing surface which comes in contact with the tank component side bearing surface, wherein the surface layer of at least one of the tank component side bearing surface and the mouthpiece side bearing surface is formed of a layer having abrasion resistance larger than that of a base material.

The fastening force of the tank component (e.g., a valve assembly) in a thrust direction is preferably kept constant. Usually, the valve assembly is fastened with a constant torque to obtain a constant fastening force (so-called torque management). However, for example, when the valve assembly is once detached and attached again for inspection, foreign matter is sometimes interposed between the bearing surfaces, or the bearing surfaces are damaged. In a case where the valve assembly is fastened as it is, even when a constant torque is given, the fastening force sometimes cannot be kept constant. On the other hand, according to the joining structure of the present invention, the surface layer of at least one of the bearing surfaces which come in contact with each other is formed of the layer having the abrasion resistance larger than that of the base material, so that during, for example, the joining of the tank components, the damage on the bearing surfaces which come in sliding contact with each other can be suppressed. Moreover, when the bearing surfaces come in sliding contact with each other, the generation of foreign matter such as fine cutting residue or dust can be suppressed.

In the present invention, at least one of the mouthpiece and the tank component is made of a metal, and the surface layer of the bearing surface of the mouthpiece or the tank component made of the metal is an oxide film obtained by subjecting the base material to an anodization treatment.

Furthermore, in the present invention, at least one of the mouthpiece and the tank component is made of an aluminum-containing metal, and the surface layer of the bearing surface of the mouthpiece or the tank component made of the aluminum-containing metal is made of alumina.

In addition, according to the present invention, there is provided a joining structure of tank components to be joined to a mouthpiece of a high-pressure tank, comprising: a screw joining unit to be joined to the mouthpiece; a tank component side bearing surface which axially comes in contact with the mouthpiece; a mouthpiece side bearing surface which comes in contact with the tank component side bearing surface; a recess provided on the inner peripheral side of a portion where the tank component side bearing surface and the mouthpiece side bearing surface come in contact with each other and on the outer peripheral side of an opening of the mouthpiece so as to form a space between the tank component and the mouthpiece; and a foreign matter intrusion suppressing seal member provided in the recess so as to prevent the intrusion of foreign matter into the opening of the mouthpiece. In this case, the surface of at least one of the tank component side bearing surface and the mouthpiece side bearing surface is preferably subjected to an abrasion resisting treatment.

In this joining structure, for example, an annular recess is formed around the opening of the mouthpiece, and an annular bearing surface (a surface abutment portion between the tank component and the mouthpiece) is further formed around the recess. In this case, the recess which forms the space between the tank component and the mouthpiece functions so that the tank component does not come in sliding contact with the mouthpiece. That is, the recess functions so that any foreign matter is not generated around the opening. Therefore, in such a joining structure, if the foreign matter (cutting residue, burrs, dust, etc.) sometimes generated at a time when the outer peripheral bearing surfaces (surface abutment portions) come in sliding contact with each other intrude into the opening of the mouthpiece, the foreign matter has to pass through the space. In the present invention, the seal member provided in this space suppresses the intrusion of the foreign matter into the opening of the mouthpiece. Moreover, in a case where at least one of the bearing surfaces which come in contact with each other is subjected to the abrasion resisting treatment, it can be prevented that the bearing surfaces are damaged or that foreign matter is generated owing to the sliding contact.

Furthermore, it is also preferable that a foreign matter intrusion suppressing stepped portion to suppress the intrusion of the foreign matter into the opening of the mouthpiece is formed on the inner peripheral side of the portion where the tank component side bearing surface and the mouthpiece side bearing surface come in contact with each other and on the outer peripheral side of the opening of the mouthpiece. The stepped portion formed in this manner can function as a stopper to prevent the foreign matter from reaching the opening of the mouthpiece, even when the foreign matter is generated owing to the sliding contact between the bearing surfaces.

Moreover, the foreign matter intrusion suppressing seal member may be provided on a part provided with the stepped portion.

### BRIEF DESCRIPTION OF THE DRAWINGS

FIG. 1 is a constitution diagram schematically showing a fuel cell system in the present embodiment;

FIG. 2 is a sectional view of a valve assembly and the like showing one embodiment of the present invention;

FIG. 3 is a partially enlarged sectional view showing one example of a joining structure in which a recess is provided with a stepped portion; and

FIG. 4 is a partially enlarged sectional view showing one example of a joining structure in which the recess is provided with the stepped portion and the stepped portion is provided with a foreign matter intrusion suppressing seal member.

### DETAILED DESCRIPTION OF PREFERRED EMBODIMENT

A preferable embodiment of the present invention will hereinafter be described with reference to the drawings.

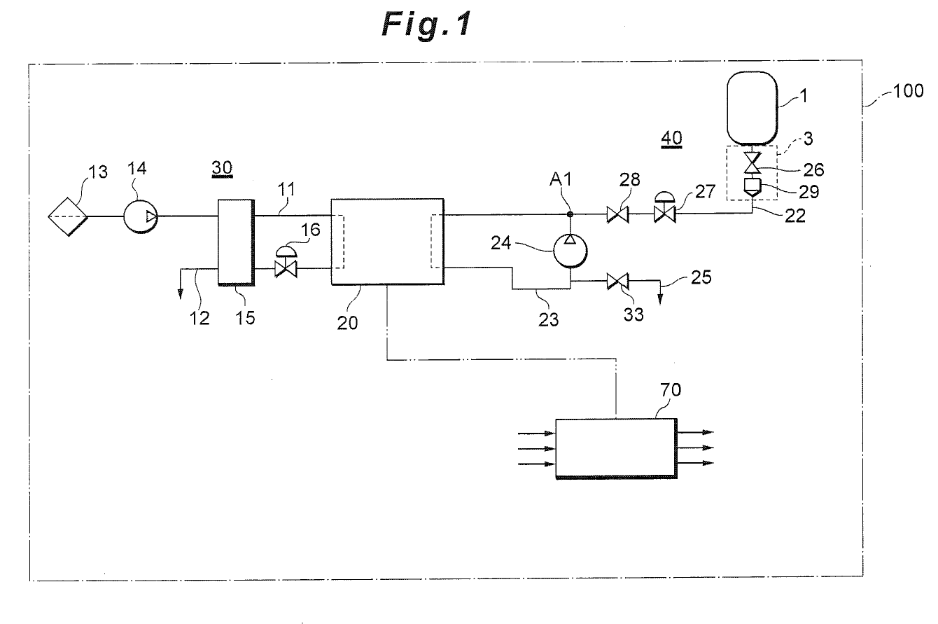

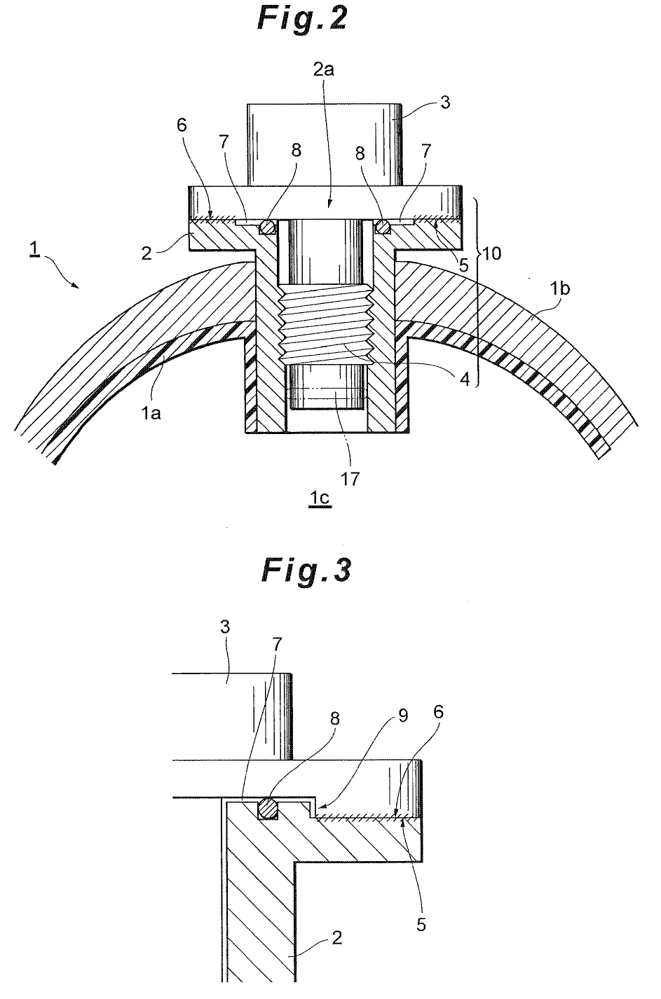

FIGS. 1 to 4 show the embodiment of a joining structure of tank components according to the present invention. The joining structure (more specifically, a joining structure for joining a tank component 3 to a mouthpiece 2, denoted with reference numeral 10 in FIG. 2) of the tank component 3 according to the present invention joins the tank component (hereinafter referred to also as a valve assembly) 3 such as the valve assembly to be attached to the mouthpiece 2 of a high-pressure tank 1. A case where one embodiment of the joining structure of the valve assembly (the tank component) 3 is applied to a high-pressure hydrogen tank for a fuel cell car will hereinafter be described.

First, a fuel cell system in the present embodiment will schematically be described (see FIG. 1). This fuel cell system 100 is constituted as a system including a fuel cell 20, an oxidizing gas piping system 30 which supplies air (oxygen) as an oxidizing gas to the fuel cell 20, a fuel gas piping system 40 which supplies hydrogen as a fuel gas to the fuel cell 20, and a control unit 70 which generally controls the whole system.

The fuel cell 20 is constituted of, for example, a solid polymer electrolytic type, and has a stack structure in which a large number of unitary cells are laminated. Each of the unitary cells of the fuel cell 20 has an air pole on one surface of an electrolyte constituted of an ion exchange membrane, has a fuel pole on the other surface thereof, and further has a pair of separators so as to sandwich the air pole and the fuel pole from both sides. The fuel gas is supplied to a fuel gas passage of one of the separators, and the oxidizing gas is supplied to an oxidizing gas passage of the other separator. When the gases are supplied in this manner, the fuel cell 20 generates electric power.

The oxidizing gas piping system 30 has a supply path 11 through which the oxidizing gas to be supplied to the fuel cell 20 flows, and a discharge path 12 through which an oxidizing off gas discharged from the fuel cell 20 flows. The supply path 11 is provided with a compressor 14 which takes the oxidizing gas via a filter 13, and a humidifier 15 which humidifies the oxidizing gas fed under pressure by the compressor 14. The oxidizing off gas flowing through the discharge path 12 passes through a back pressure adjustment valve 16 for use in water content exchange in the humidifier 15, and then the gas is finally discharged as an exhaust gas to the atmosphere outside the system.

The fuel gas piping system 40 has a high-pressure hydrogen tank (referred to as the high-pressure tank in the present specification) 1 as a fuel supply source; a supply path 22 through which a hydrogen gas to be supplied from the high-pressure tank 1 to the fuel cell 20 flows; a circulation path 23 which returns a hydrogen off gas (a fuel off gas) discharged from the fuel cell 20 to a joining part A of the supply path 22; a pump 24 which feeds the hydrogen off gas under pressure from the circulation path 23 to the supply path 22; and a discharge path 25 branched and connected to the circulation path 23.

The high-pressure tank 1 is constituted so that, for example, 35 MPa or 70 MPa of hydrogen gas can be stored. When a main valve 26 of the high-pressure tank 1 is opened, the hydrogen gas flows out to the supply path 22. Afterward, the flow rate and the pressure of the hydrogen gas are adjusted by an injector 29, then the pressure is finally reduced into, for example, about 200 kPa by a pressure reduction valve such as a mechanical regulator valve 27 on the downstream side, and the gas is supplied to the fuel cell 20. The main valve 26 and the injector 29 are incorporated in the tank component 3 shown by a broken frame line in FIG. 1, and the tank component 3 is connected to the high-pressure tank 1.

A blocking valve 28 is provided on the upstream side of the joining part A of the supply path 22. A circulation system of the hydrogen gas is constituted by connecting a downstream-side passage of the joining part A of the supply path 22, a fuel gas passage formed in the separator of the fuel cell 20, and the circulation path 23 in this order. A purge valve 33 on the discharge path 25 is appropriately opened during the operation of the fuel cell system 100, whereby impurities in the hydrogen off gas are discharged together with the hydrogen off gas to a hydrogen diluter (not shown). When the purge valve 33 opens, the concentration of the impurities in the hydrogen off gas of the circulation path 23 lowers, and the hydrogen concentration in the hydrogen off gas to be circulated and fed increases.

The control unit 70 is constituted as a microcomputer including therein a CPU, an ROM and an RAM. The CPU executes desired computation in accordance with a control program to perform various types of processing and control, for example, the flow rate control of the injector 29. The ROM stores the control program and control data to be processed by the CPU. The RAM is used as any type of operation region mainly for control processing. The control unit 70 inputs detection signals of various types of pressure and temperature sensors for use in the gas systems (30, 40) and a refrigerant system (not shown), to output control signals to constituent elements.

Subsequently, the joining structure of the tank components will be described (see FIG. 2, etc.).

The joining structure of the tank components according to the present invention is a preferable technology in a case where at least one of the mouthpiece 2 and the tank component 3 is made of an aluminum-containing metal, and the structure is especially preferable as a technology for suppressing remarkable abrasion in a case where both of them are made of the aluminum-containing metal. Here, examples of the aluminum-containing metal include aluminum alone, and an alloy of at least one additive selected from the group consisting of magnesium, silicon and zinc, and aluminum. However, even in a case where a material is a metal which does not contain aluminum, the present invention is applicable to any material as long as the material might abrade bearing surfaces 5, 6.

The high-pressure tank 1 has a structure in which the mouthpiece 2 is provided on one end of a sealed cylindrical main body constituting the body of the high-pressure tank 1 (see FIG. 2). The main body has a double layer structure including a resin liner la formed on an inner side so as to suppress the transmission of a gas stored in the structure to the outside, and a shell 1b which covers the outer side of the resin liner 1a and which is made of, for example, CFRP or GFRP. Moreover, the inside of the main body of the high-pressure tank 1 is a storage space 1c in which the hydrogen gas is received at a high pressure (see FIG. 2). It is to be noted that in the present embodiment, the liner la made of a resin is used. However, as another example, an aluminum-containing metal liner (e.g., an aluminum liner) or the like may be used.

The mouthpiece 2 is made of, for example, an aluminum-containing metal or the like, and is provided on the center of a spherical end wall portion of the tank main body. Moreover, the tank component 3 is screwed into the mouthpiece 2 and detachably joined to the mouthpiece via an internal thread formed on the inner peripheral surface of this mouthpiece 2.

The valve assembly 3 is a component constituting a gas discharge unit in the high-pressure tank 1. Although not especially shown in the drawings, the assembly has a structure in which high-pressure valves are arranged in series and an injector is embedded. Moreover, a housing of this valve assembly 3 is made of an aluminum alloy. Although not especially shown in the drawings, the housing may be provided with another valve such as a safety valve (a relief valve, a fusible plug valve) or a check valve in addition to the injector and the like.

Moreover, the structure for joining the above valve assembly 3 to the high-pressure tank 1 includes a screw joining unit 4 to be joined to the mouthpiece 2; a valve assembly 3 side bearing surface 5 which axially comes in contact with the mouthpiece 2; a mouthpiece 2 side bearing surface 6 which comes in contact with the valve assembly 3 side bearing surface 5; a recess 7 provided on the inner peripheral side of a portion where the valve assembly 3 side bearing surface 5 and the mouthpiece 2 side bearing surface 6 come in contact with each other and on the outer peripheral side of an opening 2a of the mouthpiece 2 so as to form a space between the valve assembly 3 and the mouthpiece 2; and a foreign matter intrusion suppressing seal member 8 provided in the recess 7 so as to prevent the intrusion of foreign matter into the opening 2a of the mouthpiece 2. In consequence, the valve assembly 3 can detachably be joined to the high-pressure tank 1 (see FIG. 2, etc.).

The screw joining unit 4 is a unit formed so as to join the valve assembly 3 to the mouthpiece 2. More specifically, the unit is an external thread formed on the outer peripheral surface of the valve assembly 3 so as to engage with the internal thread provided on the inner peripheral surface of the mouthpiece 2. For example, in the present embodiment, a part of the valve assembly 3 is a small diameter portion to be received in the mouthpiece 2, and the above screw joining unit 4 is formed on the middle of this small diameter portion (see FIG. 2).

The bearing surfaces 5, 6 are contact surfaces which come in contact with each other in a case where the valve assembly 3 is joined to the mouthpiece 2, and the surfaces are formed on the valve assembly 3 side and the mouthpiece 2 side, respectively (see FIG. 2). For example, in the present embodiment, the mouthpiece 2 side bearing surface 6 of the bearing surfaces is annularly and flatly formed on the upper surface of a flange-like portion formed on the mouthpiece 2. On the other hand, the valve assembly 3 side bearing surface 5 is formed as the lower surface of the flange-like portion formed on the valve assembly 3 and an annular region which comes in contact with the mouthpiece 2 side bearing surface 6.

Here, the surface of at least one of the valve assembly 3 side bearing surface 5 and the mouthpiece 2 side bearing surface 6 is preferably subjected to an abrasion resisting treatment or the like to form a surface layer having an abrasion resistance larger than that of a base material (see a finely hatched portion in FIG. 2). In a case where the surface (a surface abutment portion) of at least one of the bearing surfaces 5, 6 which come in contact with each other is subjected to a certain treatment for abrasion resisting, it can be prevented that the bearing surfaces 5, 6 which come in sliding contact with each other are damaged during, for example, the joining of the valve assembly 3. Moreover, it can be prevented that foreign matter such as fine cutting residue or dust is generated in a case where the bearing surfaces 5, 6 come in sliding contact with each other. As an example of the abrasion resisting treatment capable of producing such an effect, the bearing surface 5 (6) is subjected to an abrasion resisting surface treatment such as plating or thermal spraying, and is further processed so as to smoothen the surface if necessary. Instead of the plating or the thermal spraying, welding, vapor deposition, an alumite process, aluminum painting or the like may be performed. Alternatively, coating with a grease-like material such as a liquid gasket can be performed to form an abrasion resisting thin film on the surface. Moreover, in addition to the formation of such a thin film, examples of the treatment include a treatment in which polishing or cutting (removal processing), case hardening or the like is performed to form the bearing surface 5 (6) into a fine surface and to decrease so-called surface roughness, and a treatment in which the surface is prevented from cracking.

Moreover, an alumite treatment and the like will additionally be described. For example, electrolysis (i.e., an anodization treatment) is performed in an electrolytic solution such as a sulfuric acid solution by use of a member (an aluminum valve) having the bearing surface 5 as an anode, to form an oxide film on the surface of the bearing surface 5. In general, this type of oxide film is harder than the base material, and hence has an excellent abrasion resistance as compared with the base material. Here, when the member is made of an aluminum-containing metal, alumina (Al₂O₃) is formed on the surface of the member. Such an anodization treatment is advantageous in that close contact properties between the surface layer (the oxide film) and the base material are high and hence durability increases or in that a new coating material except the electrolytic solution is unnecessary and hence economical properties are high.

It is to be noted that the whole surface of the valve assembly 3 or the mouthpiece 2 may be subjected to the anodization treatment, but at least one bearing surface 5 (6) may be subjected to the treatment in order to obtain the above-mentioned predetermined function and effect. Moreover, a screw portion of the valve assembly 3 or the mouthpiece 2 may be masked so that the portion does not come in contact with any electrolytic solution, when subjected to the anodization treatment.

Furthermore, in the present invention, at least one of the mouthpiece and the tank component is made of an aluminum-containing metal, and the surface layer of the bearing surface on the side made of the aluminum-containing metal is made of alumina.

Moreover, in the present embodiment, the annular recess 7 is formed around the opening 2a of the mouthpiece 2 (see FIG. 2). As to the recess 7 formed in this manner, an annular (more specifically, a holed-coin-like shape) space is formed between the mouthpiece 2 (the opening 2a) and the valve assembly 3. Therefore, the recess functions so as to prevent that the mouthpiece 2 and the valve assembly 3 which face each other do not come in contact with each other in a region provided with the recess 7. In consequence, in a region around the opening 2a, the foreign matter (the cutting residue, burr, dust, etc.) due to the contact between the mouthpiece 2 and the valve assembly 3 are not generated. The foreign matter is generated, if any, in a region where the mouthpiece and the valve assembly come in contact with each other, that is, in a case where the outermost peripheral bearing surfaces (surface abutment portions) 5, 6 come in sliding contact with each other. Even in a case where the foreign matter is generated in this manner, if the foreign matter does not pass through a space formed by the recess 7 as described above, the foreign matter does not intrude into the opening 2a. It is to be noted that from a viewpoint that the moving and intruding of the foreign matter into the opening 2a should be suppressed as described above, a smaller clearance formed by the recess 7 is preferable.

Furthermore, in the present embodiment, the annular (the holed-coin-like shape) formed by the recess 7 is provided with the seal member 8 for suppressing the intrusion of the foreign matter into the opening 2a of the mouthpiece 2 (see FIG. 2). For example, even when the bearing surface 5 and 6 come in sliding contact with each other to generate the foreign matter as described above, the seal member 8 functions as a wall around the opening 2a, thereby preventing the foreign matter from moving further internally. Therefore, the generated foreign matter does not pass through the opening 2a or do not intrude into the high-pressure tank 1.

There is not any special restriction on the specific structure of this seal member 8. However, in the present embodiment, an annular groove is formed around the opening 2a of the mouthpiece 2, and an O-ring fitted into this annular groove can function as the seal member 8 (see FIG. 2). It is to be noted that in the present embodiment, the O-ring having a schematically circular sectional shape is used, but this is merely one example, and another shape such as a hexagonal sectional shape may be used. In short, there is not any special restriction on the seal member 8 as long as the seal member is deformed and brought into contact under pressure with both of the mouthpiece 2 and the valve assembly 3, when the valve assembly 3 is joined (attached) to the mouthpiece 2. In other words, the thickness of the seal member 8 may be set to such an extent that the thickness exceeds the sum of the clearance of the recess 7 and the depth of the annular groove. Moreover, in the present embodiment, the annular groove is provided in the mouthpiece 2 to fit the O-ring into the groove. Conversely, the annular groove may be provided in the valve assembly 3, or annular grooves may similarly be provided in both of the mouthpiece and the valve assembly so that the O-ring fits into both the grooves.

It is to be noted that the distal end of the small diameter portion of the valve assembly 3 on a tank main body side (a portion closer to the high-pressure tank 1 from the screw joining unit 4) is provided with a sealing member 17 for hermetically receiving the hydrogen gas to be stored in the tank at a high pressure (e.g., 35 MPa or 70 MPa) in the high-pressure tank 1 (see FIG. 2). The sealing member 17 is constituted of, for example, an O-ring to be fitted into the annular groove of the small diameter portion of the valve assembly 3.

In the high-pressure tank 1 of the present embodiment including the above-mentioned joining structure, since the surface (the surface abutment portion) of at least one of the bearing surfaces 5, 6 which come in contact with each other is subjected to the abrasion resisting treatment, the bearing surfaces 5, 6 which come in sliding contact with each other can be prevented from being damaged, for example, during the joining of the valve assembly 3. Moreover, it can be prevented that foreign matter such as the fine cutting residue or dust is generated in a case where the bearing surfaces 5, 6 come in sliding contact with each other.

Therefore, the high-pressure tank 1 according to the present embodiment has an advantage that a fastening torque during the joining of the tank components is stabilized. That is, the fastening force of the tank component (e.g., the valve assembly) 3 in a thrust direction is preferably kept constant, and the valve assembly 3 is usually fastened with a constant torque to obtain a constant fastening force (so-called torque management). On the other hand, for example, when the valve assembly 3 is once detached and attached again for inspection, the foreign matter is sometimes interposed between the bearing surfaces 5 and 6, or the bearing surfaces 5, 6 are damaged. In a case where the valve assembly 3 is fastened as it is, even when a constant torque is given, the fastening force sometimes cannot be kept constant. In this respect, according to the high-pressure tank 1 of the present embodiment, the generation of the foreign matter can be suppressed in a case where the bearing surfaces 5, 6 come in sliding contact with each other. Therefore, the damaging or the like of the bearing surfaces 5, 6 can be avoided, and a friction coefficient can be prevented from changing to stabilize the fastening torque. Therefore, the torque management can continuously be performed. Moreover, even when the tank component (the valve assembly) 3 is detached and attached, the component can be reused.

Additionally, in the present embodiment, the bearing surfaces 5, 6 are formed on the outer peripheral side of the surfaces of the mouthpiece 2 and the valve assembly 3 which face each other, that is, portions disposed away from the opening 2a, and further the space constituted of the recess 7 is formed between the bearing surfaces 5, 6 and the opening 2a, so that the bearing surfaces abut on each other only on the outer peripheral side. In other words, even if the foreign matter is generated, the foreign matter can be generated in a region disposed away from the opening 2a. Therefore, even if the foreign matter is generated in the bearing surface 5, 6, the foreign matter does not easily intrude into the opening 2a. In addition, since the recess 7 is provided with the foreign matter intrusion suppressing seal member 8, it can effectively be prevented that the foreign matter moves to the opening 2a and intrude into the tank from the opening.

It is to be noted that the above embodiment is one example of the preferable embodiment of the present invention, but the present invention is not limited to this embodiment, and can variously be modified without departing from the scope of the present invention. For example, it has been described in the above embodiment that the present invention is applied to the valve assembly 3 and the mouthpiece 2 made of aluminum or an aluminum-containing alloy, but the application target of the present invention is not limited to them. Even in a case where the present invention is applied to a valve component or the like using a material whose surface might be abraded as the base material, a predetermined function and effect can be obtained.

Moreover, it has been described in the above embodiment that the recess 7 is provided on the mouthpiece 2 side. Conversely, the recess 7 may be provided on the valve assembly (the tank component) 3 side. Alternatively, the recesses 7 may be provided in both of them to form a space.

Furthermore, a foreign matter intrusion suppressing stepped portion 9 for suppressing the intrusion of the foreign matter into the opening 2a is preferably formed on the inner peripheral side of the portion between the valve assembly 3 side bearing surface 5 and the mouthpiece 2 side bearing surface 6 come in contact with each other and on the outer peripheral side of the opening 2a of the mouthpiece 2. Even if the foreign matter is generated owing to the sliding contact between the bearing surfaces 5 and 6, the stepped portion 9 formed in this manner can function as a stopper for preventing the foreign matter from reaching the opening 2a of the mouthpiece 2. One example of a specific configuration will be described. As shown in, for example, FIG. 3, the stepped portion 9 may be provided between the bearing surfaces 5, 6 and the recess 7 so that the stepped portion functions as the stopper. In this case, as shown in FIG. 3, the stepped portion 9 may becomes higher toward the valve assembly 3. Conversely, the stepped portion 9 may lower toward the high-pressure tank 1 side.

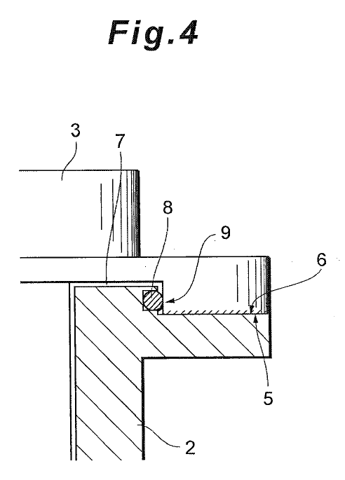

Moreover, when the stepped portion 9 is provided as described above, a part provided with the stepped portion 9 may be provided with the foreign matter intrusion suppressing seal member 8 (see FIG. 4). Even if the foreign matter is generated between the bearing surfaces 5 and 6 during the joining of the tank component (the valve assembly) 3, the part of the stepped portion 9 can function as the seal member 8, and foreign matter intrusion (the intrusion of the foreign matter) can so-called doubly be suppressed.

It is to be noted that a foreign matter intrusion suppressing constitution such as the seal member 8 or the stepped portion 9 described above can be applied to not only the tank component 3 constituted of an aluminum material (an aluminum alloy) as described in the present embodiment but also as another tank component joining structure. Even in a case where the constitution is applied to, for example, the conventional tank component 3 made of SUS or the like, it can advantageously be prevented that various foreign matter enters (intrudes) into the opening 2a of the mouthpiece 2.

Moreover, needless to say, a constitution such as the described seal member 8 or stepped portion 9 is not essential. As described above, when the bearing surface of the tank component or the like is subjected to the abrasion resisting treatment or the tank component is provided with the surface layer having the abrasion resistance larger than that of the base material, a desired function and effect can be obtained. In this case, when the seal member 8 or the stepped portion 9 is provided together, a further function and effect can be obtained.

Furthermore, the joining structure of the tank components according to the present invention can be applied to a tank having any constitution as long as the constitution is a member for a high-pressure tank having the bearing surface 5 (6) which receives the axial force of an engaged portion.

### INDUSTRIAL APPLICABILITY

According to the present invention, the abrasion resistance of a bearing surface can be improved to suppress the generation of foreign matter due to the abrasion or cutting of the bearing surface. Moreover, even when the foreign matter is generated, the intrusion of the foreign matter into a tank via an opening of a mouthpiece can be suppressed.

Therefore, the present invention can broadly be used in a joining structure of tank components demanded in this manner.

1. A joining structure of tank components to be joined to a mouthpiece of a high-pressure tank, comprising:
a screw joining unit to be joined to the mouthpiece;
a tank component side bearing surface which axially comes in contact with the mouthpiece outside an opening of the mouthpiece; and
a mouthpiece side bearing surface which comes in contact with the tank component side bearing surface,
wherein the surface layer of at least one of the tank component side bearing surface and the mouthpiece side bearing surface is formed of a layer having abrasion resistance larger than that of a base material.

2. The joining structure of the tank components according to claim 1, wherein at least one of the mouthpiece and the tank component is made of a metal, and the surface layer of the bearing surface of the mouthpiece or the tank component made of the metal is an oxide film obtained by subjecting the base material to an anodization treatment.

3. The joining structure of the tank components according to claim 1, wherein at least one of the mouthpiece and the tank component is made of an aluminum-containing metal, and the surface layer of the bearing surface of the mouthpiece or the tank component made of the aluminum-containing metal is made of alumina.

4. A joining structure of tank components to be joined to a mouthpiece of a high-pressure tank, comprising:
a screw joining unit to be joined to the mouthpiece;
a tank component side bearing surface which axially comes in contact with the mouthpiece;
a mouthpiece side bearing surface which comes in contact with the tank component side bearing surface;
a recess provided on the inner peripheral side of a portion where the tank component side bearing surface and the mouthpiece side bearing surface come in contact with each other and on the outer peripheral side of an opening of the mouthpiece so as to form a space between the tank component and the mouthpiece; and
a foreign matter intrusion suppressing seal member provided in the recess so as to prevent the intrusion of foreign matter into the opening of the mouthpiece.

5. The joining structure of the tank components according to claim 4, wherein the surface of at least one of the tank component side bearing surface and the mouthpiece side bearing surface is subjected to an abrasion resisting treatment.

6. The joining structure of the tank components according to claim 4, wherein a foreign matter intrusion suppressing stepped portion to suppress the intrusion of the foreign matter into the opening of the mouthpiece is formed on the inner peripheral side of the portion where the tank component side bearing surface and the mouthpiece side bearing surface come in contact with each other and on the outer peripheral side of the opening of the mouthpiece.

7. The joining structure of the tank components according to claim 6, wherein the foreign matter intrusion suppressing seal member is provided on a part provided with the stepped portion.

8. The joining structure of the tank components according to claim 1, wherein the seal member is provided internally from the tank component side bearing surface and the mouthpiece side bearing surface.

9. The joining structure of the tank components according to claim 4, wherein the seal member is provided internally from the tank component side bearing surface and the mouthpiece side bearing surface.
